(19) United States
(12) Patent Application Publication
(10) Pub. No.: US 2020/0111383 A1
(43) Pub. Date: Apr. 9, 2020

(54) SLEEP HYGIENE DEVICE AND METHOD

(71) Applicant: Clayton Anderson, Leland, NC (US)

(72) Inventor: Clayton Anderson, Leland, NC (US)

(21) Appl. No.: 16/153,689

(22) Filed: Oct. 5, 2018

(51) Int. Cl. G09B 19/00; G09B 5/00

(52) U.S. Cl. CPC G09B 19/00; G09B 5/00

(57) ABSTRACT

A system for training a child to develop healthy sleep hygiene, comprising a mobile indicator device and a mobile control, the device being adapted to be held, carried, grasped and stood up in the vicinity of a child, such that the child can observe a series of indicators. The indicators sequentially activate in a desired color and brightness to represent completion of intervals that cumulate in an overall period duration. The behavior of the device is controlled by inputs to a control that is in the possession of the child's parent. The appearance of the device over time provides a representation of a child's ability to feel energetic during the day and obtain restored ability to be energetic by completion of a period of sleep, before the next day.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD

At least some embodiments disclosed herein relate, in general, to sleep hygiene, night lights, stage interval timing systems, child training devices, and wireless control of mobile devices.

### BACKGROUND

Healthy sleep hygiene is important to maintaining a productive and healthy life. In varying amounts, regularly getting a certain minimum amount of sleep per day is correlated with being able to carry out tasks and activities for the hours and days following completion of a period of sleep. Also, consistency in when adequate sleep begins and ends promotes successful participation and completion of the tasks that make for a satisfying and successful life. However, it is a persistent problem throughout human history, to fail to maintain a healthy sleep routine. The reasons why any particular individual fails to maintain healthy sleep can be very specific to a person, but several stages of life are ones in which there are broadly common factors, despite widely varying individual circumstances.

One such stage of life, is pre-adolescent development. Children, and particularly very young children, and especially children that are so young that they commonly cannot tell time, are continuously experiencing biological changes and fluctuations and improvements in contextual awareness. This ongoing and often inconsistent rate of development frequently results in unanticipatable mental and physiological changes that affect the child's interest or concern for sleep or ability to sleep or ability to understand the need to practice a sleep routine or perceive factors and cues which make it possible develop and maintain a regular sleep routine or even merely a regular amount of sleep, if timing happens to be inconsistent.

Logically, then, another stage of life in which practicing a healthy sleep routine is predictably difficult, is the early years of parenthood. Because of the omnipresence of a young child, particularly in the times before and after bedtime, a child's ability to go to bed and stay in bed have a high likelihood that their poor sleep hygiene will effect delays in starting sleep, abbreviation of periods of otherwise successful periods of sleep, and interrupt a parent's ability to carry out the maximum amount of time spent asleep during a period intended to be used for continuous sleep. To rectify each of these variations, a parent may find themselves regularly conceiving new solutions and tactics to effect reclaiming or developing an alternatively practiced healthy sleep routine, in order to acquire a new routine that will effect resuming healthy sleep hygiene for the child. However, even after discovering and subsequently successfully practicing a new routine that restores a child to healthy sleep hygiene, there is no certainty that the new routine will have a positive effect upon the parent to resume or even maintain healthy sleep hygiene.

For example, it may be the case that a child very suddenly adopts a consistent pattern of being very tired after dinner, and therefore is cranky and uncooperative at bedtime, leading to inconsistent beginning and duration of sleep, though not enough that the parents suffer very much detriment. However, the inconsistent sleep begins to make the child uncooperative and distracted, during the day. To attempt to change the behavior, the parents start the child's bedtime earlier, and successful sleep and behavior are restored, but the child rises early every day and wakes the parents, beginning a period of regular sleep deprivation that begins to impact the parent's performance during their own workday.

Essentially, even a sudden improvement or change or decline in a child's sleep hygiene can result in a persistent loss of the parent's ability to maintain their own healthy sleep hygiene, even if such parents have successfully practiced healthy sleep hygiene for years, leading up to parenthood, even through changes of circumstance that required changes in routine. In fact, it is arguable that someone with many years of healthy sleep hygiene before parenthood is the most likely to suffer significant detriment than those without a history of good sleep hygiene.

In sum (and in addition to the above), there are several persistent problems in the art. Children perceive sleep as punishment; children do not want to go to bed; children do not begin bedtime consistently; children do not get enough sleep; children wake from sleep too early, children do not stay in bed or attempt to go back to sleep; children do not use or have the ability to use or view a clock (to decide whether to go back to bed, after leaving bed); children are tempted out of bed by amount of ambient light; children have no sense of achievement in practicing healthy sleep; children do not know whether their parents need more sleep at any particular time after rising; children do not know whether rising from bed after waking is going to upset parents; children lack indicators that their own healthy and restorative sleep may not be a good indicator that they should leave bed; children lack perception of how passage of time consumes their daily energy, and lack cues to inform them of the expiring amount of time before a bedtime.

There is therefore a persistent need in the art to provide a solution which solves any and all of these problems, so that both young children and parents of young children are able to achieve and maintain a healthy sleep routine.

### SUMMARY

The present invention comprises various embodiments, including several that present a system that is able to function as a tool for training a child to practice good sleep hygiene.

The invention facilitates practicing a healthy lifestyle for both children and parents through increased awareness and feedback as to the amount of energy that a child should understand about their health at any particular time during the day and night. Here, “energy” is not limited to the literal definitions of energy in discrete units (oules, kJ, Nm), but is more specifically referring to the figurative sense of energy, meaning restfulness and alertness, in an estimable quality, or proportion, relative to whether consciousness or unconsciousness is desirable.

The system is adapted to provide a child with a continuously or regularly present reference tool that a child can understand as showing how much “energy” they have gained at any stage during sleep and have remaining at any point during the rest of the child's day.

To achieve this perception, the system comprises an indicator device and remote controller. The indicator device is the visual reference provided the child, to adopt this perception of the aforesaid concepts of increasing and decreasing amounts of energy. The indicator device comprises a plurality of indicators, which are arranged geometrically linearly and sized similarly to one another. The indicator device is adapted to accompany the child in the child's place of sleep or nearby, and progressively illuminate each of the indicators in series over the course of a set period during which the child is expected to sleep.

These factors promote the child to understand that more lights means more “energy,” and that more sleep means more “energy,” because more lights appear as time passes over the course of the period of sleep. Preferably, though, the promotion of the perception about this progression that teaches the child about the value of sleep is not used literally, because a child achieving sleep in linear clumps is unlikely to actually have a healthy sleep routine.

While healthy sleep is practiced by having a regular beginning time, a regular ending time, and a regular amount of sleep during the period between bedtime and wake time, the benefit of sleep is front-loaded. “Front-loaded,” is meant to convey that it is a reasonable presumption that successfully getting a healthy amount of sleep during the intended period of sleep is achieved by successfully managing to go to sleep and then stay in uninterrupted sleep for a significant period during the overall sleep period duration, between bedtime and wake time.

The ideal scenario is where sleep begins instantaneously at bedtime and ends immediately at the intended wake time, but this is unrealistic. What is more likely, even for a child that is merely waking too early (in the context of attempting to sleep overnight, rather than a nap) is that they are getting some significant amount of time of beneficial sleep, and then regularly incur waking early, relative to their own health, or to the parents sleep routine. Therefore, the device is intended to be used according to non-linear intervals, so that the child observes progress that is correlated with times of relative value, in consideration of the different detriments to waking at any particular time. Greater detail of several exemplary embodiments can be found in the detailed description.

To help the child develop an affinity with the device, an exemplary embodiment follows:

the device is shaped like a battery, and the indicators are arranged along the length of the “battery,” making the indicators' progression appear to represent the “battery” being recharged. Since this apparent “recharging” occurs according to the child's sleep times, the device seems less like a time representation and more as a representation of the child's state, herself. The device then has metaphorical value as being the child's own battery charge indicator.

Just as a rechargeable device does not leave its battery indicator behind, the indicator device is sized and shaped so that the child can easily take it with them and have it nearby in many of the places that they carry out their day. The device is adapted to also deluminate the indicators over the course of the day, a representation of the consumption of energy, reinforcing the necessary concept that, as the indicators illuminate during the night, the child is accumulating “energy.” The device is adapted to time the deluminations so that the battery appears to be nearly empty at bedtime, signaling that the child should prepare for bedtime. Then, when bedtime arrives, the child can simply take the device with them.

At any time during the day, the flat bottomed shape of a battery facilitates it being able to stand on any roughly horizontal surface, and the indicators, arranged along the length, thereby can be seen, from any position around the device, that charge is going up or going down. Because the device has a regular geometry about its periphery, several contemplated embodiments arrange the indicators so that each can be viewed from a wide angle about its periphery. Therefore, unlike a clock, the device can be passively viewed for its illumination value from many positions, and be equally understood by anyone with any view of that position, regardless of the distance or angle of view. Even if the child herself does not notice the state of the device at any particular time, the ability to be seen and understood without conscious intent, from so many positions increases the likelihood and frequency of more viewers being aware of it, or even that the two viewers, might discuss the amount of time left in the day, before bedtime (or since waking).

The device is particularly valuable to children that have yet to learn how to tell time, because the illumination is correlated with the general understanding of the child's beginning and ending of sleep, without reporting the number of hours or the beginning or ending of time for any child's past or future period of sleep.

While the device, in its broadest notions, is not a time indicator, the intervals must have some duration criteria and set for the circumstances personal to the child or to the parent's preferences. Since the device is supposed to be merely a mobile indicator of apparent “energy” state to the child, and where the appearance and illumination behavior is intended to obscure how it can be reconfigured or the times associated with its operation, the system comprises the remote controller in order to input parameters to the device. Some exemplary inputs include bedtime, wake time, interval duration, overall period of duration, or desired algorithm or pattern for determining any of the above parameters.

### BRIEF DESCRIPTION OF THE DRAWINGS

The embodiments are illustrated by way of example and not limitation in the figures of the accompanying drawings in which like references indicate similar elements.

FIG. 1 shows a mobile sleep hygiene training system.

FIG. 2A is a diagram of a pattern of illuminating indicators in successive stages.

FIG. 2B is a diagram of a timeline for timing a pattern of illuminating indicators.

FIG. 2C is a diagram of a timeline for timing a pattern of illuminating indicators.

FIG. 3 shows several locations of an indicator device in a shared space.

FIG. 4 shows a child carrying an indicator device in a hallway.

FIG. 5 shows locations of an indicator device in a place of sleep.

FIG. 6A shows a graphical representation of a set up controller screen.

FIG. 6B shows a graphical representation of a controller screen during a nap

FIG. 6C shows a graphical representation of an edit controller screen during a nap.

FIG. 6D shows a graphical representation of a set up controller screen.

FIG. 7 shows a child viewing an indicator device in a hallway.

FIG. 8 shows a child viewing an indicator device in a hallway.

FIG. 9 shows a child viewing an indicator device in a hallway.

FIG. 10 shows a child viewing an indicator device in a hallway.

FIG. 11 shows a child viewing an indicator device in a hallway.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

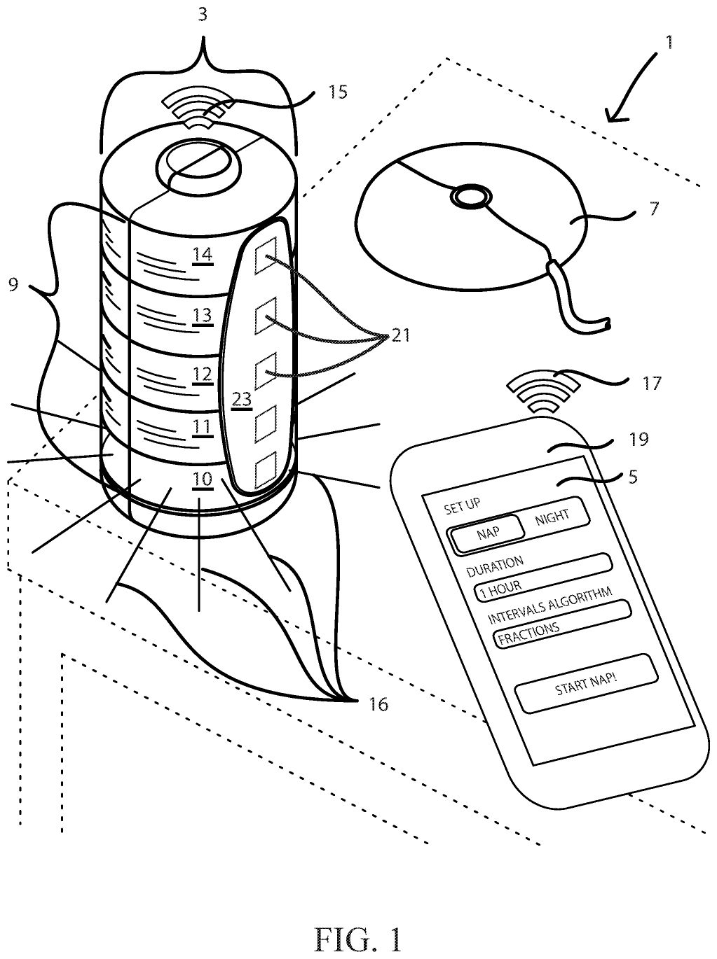

Referring now to FIG. 1, what is shown is an exemplary embodiment of the present invention, a mobile sleep hygiene training system 1.

This embodiment of the system 1 operates as a tool for training a child to practice good sleep hygiene and recognize a relationship between practicing sleep routines and accumulating energy for the child's body and mind to be used the next day, or otherwise following a period of sleep. Here, “child” includes any person using the device to build good sleep habits and hygiene. “Parent” should be understood to include any person with an expectation of setting or editing the planned sleep of a child.

The system comprises an indicator device 3, a remote controller 5, and a recharging dock 7. The device 3 is shown standing upright, and comprises a shape which is similar to a battery having a predominantly cylindrical shape characterized by a predominant length.

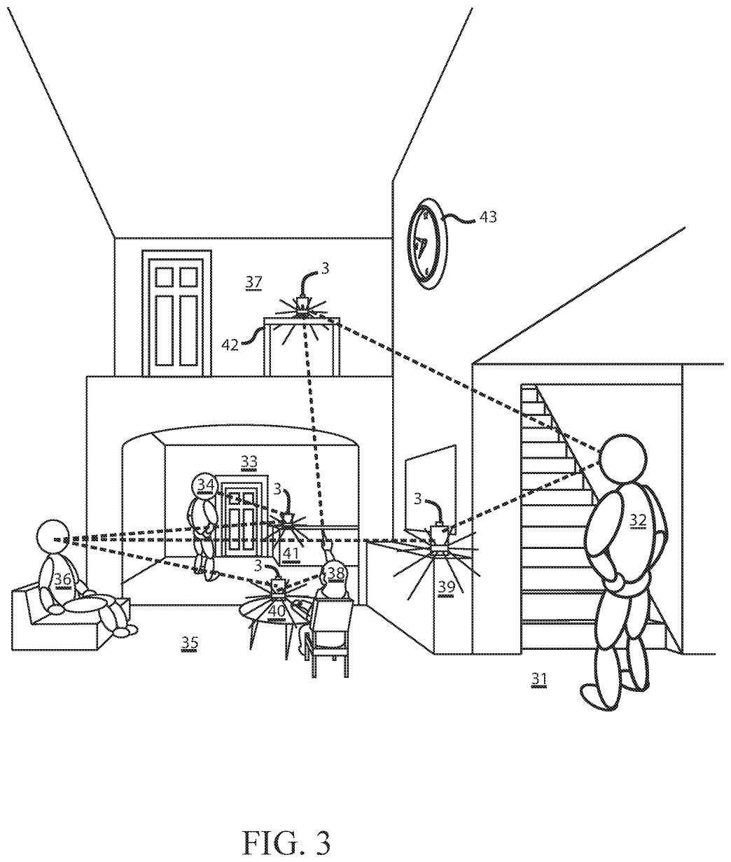

The indicator device 3 comprises a plurality of indicators 9 (specifically, this embodiment comprises five indicators 10, 11, 12, 13, 14). Indicators 10-14 are adapted to being progressively illuminated to emit light peripherally about the device 3. Indicator 10 is a first indicator and is activated to be illuminated to emit light 16 peripherally about the device 3. Indicators 11-14 are not illuminated in this drawing. In another embodiment, not shown, rather than any of Indicators 10-14 being alternately activated to be illuminated and not illuminated, the Indicators 10-14 are alternately activated to be alternately illuminated in degree of brightness and shade of color. For clarity, the depicted indicators are shown in either illuminated or not illuminated state. For more detail about some exemplary embodiments and modes in which the device activates and deactivates indicators in a manner other than merely alternately illuminated and not illuminated, see FIG. 3.

The device 3 comprises mobile communications 15, and is controllable remotely with the remote controller 5 via wireless communications 17. In the present figure, the wireless communications 17 are provided to the controller 5 by a mobile device 19.

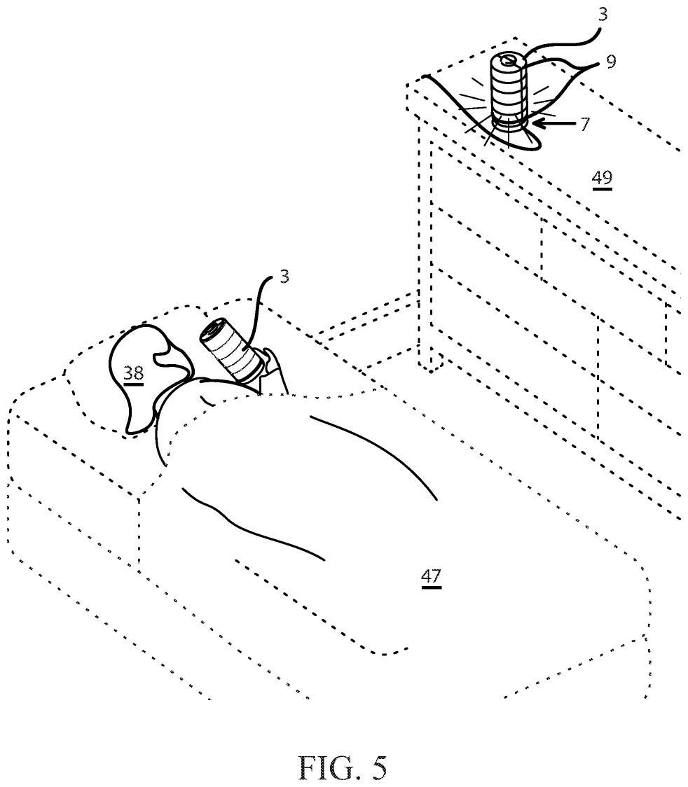

The device 3 also comprises a secondary set of indicators 21, which are adapted to be activated similarly to the plurality 9 of indicators 10-14. The secondary indicators 21 shown are adapted to be activatable with a squeezable switch 23, so that the device 3 may be operated in modes in which it is desirable to minimize the total light output until or unless actively desired. In such modes, the primary indicators 10-14 would be de-activated, and the secondary indicators 21 would be toggle-able to be illuminated with the switch 23, whenever desired. See FIG. 5 for one such mode, when the device 3 is used in bed with a child.

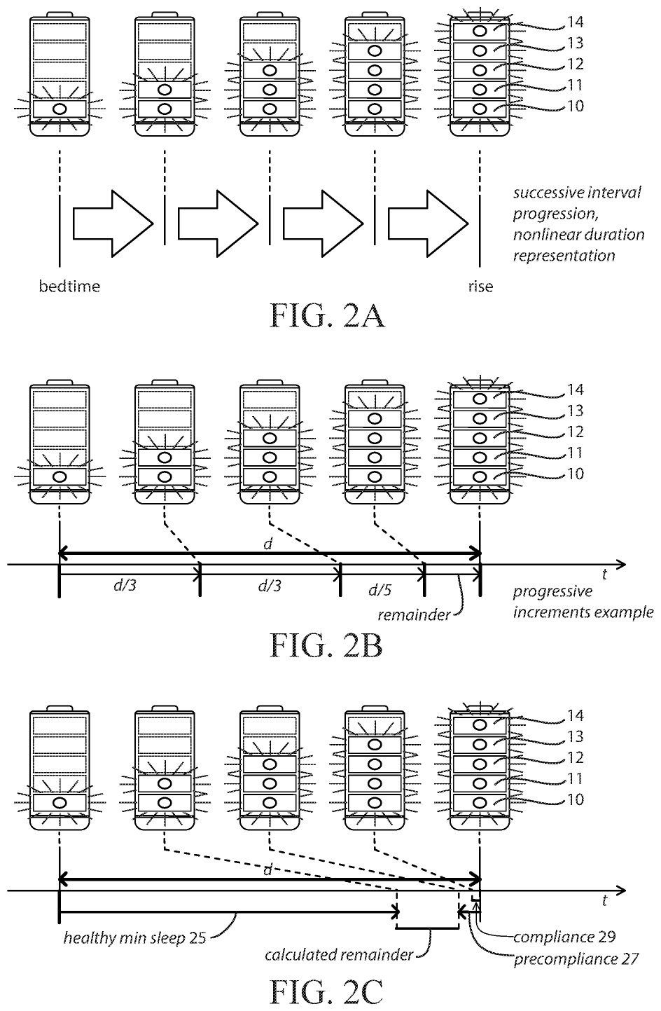

The device 3 is constructed and arranged to operate in a manner of patterned timing illumination that promotes perception of sleep as a series of progressive stages with proportional value, rather than as markers in time. See FIGS. 2A-2C.

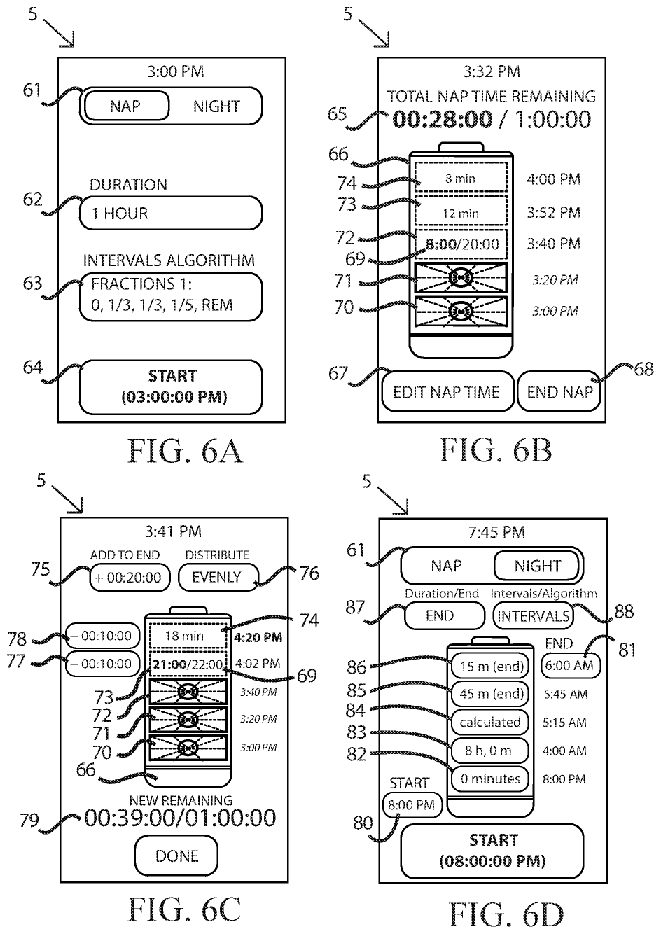

While the indicators are arranged to be sequentially activated with completion (or beginning) of each of the successive stages, each stage is a non-linear time interval having a desired or calculated duration that is not required to have any particular association with time of day or any particular strict relationship with the durations desired for the other intervals. The intervals are customizable and able to be monitored and edited before and during an active period of sleep by the parent, using the remote controller 5. See FIGS. 6A-D.

Referring now to FIGS. 2A-C, there are shown three patterns of illuminating the indicators (10-14): the pattern of the apparent behavior in successive stages of valuable intervals of completed sleep, which seems proportional to a child experiencing a sporadically conscious timeline of observance (FIG. 2A) during a period of sleep, and two actual, alternative underlying non-linear timing patterns of such intervals, apparent to a parent with the ability to set and directly observe the timing of the indicators 10-14 (FIGS. 2B, 2C).

Referring now to FIG. 2A, what is shown is a diagram of the apparent behavior of the device 3, from the perspective of the child, who is without access to the details of the actual timing of the indicators 10-14, during the course of a period of sleep. The increments are in uniform steps of illumination, and appears to be a successive progression of equally important stages, despite the intervals being of nonlinear duration with respect to one another. The apparently linear value is facilitated by the fact that a child is likely to be unconscious during a significant portion of each sleep interval. Children which are conscious often during the period of sleep and attentive enough while conscious are able gain the benefit of seeing that the value remains linearly acquired, if their extended duration of observance does happen to allow detection of a nonlinear duration across the intervals.

Referring now to FIG. 2B, what is shown is an exemplary embodiment of setting the timing of the activation of the indicators (10-14), in a pattern of progressive non-overlapping fractional increments of duration of a period of sleep. The exemplary fractions given divide an input duration (“d”) for the period of sleep into time intervals of “0,” “d/3,” “d/3,” “d/5,” and the remainder (−13%) of the input duration. Completion of each interval results in the successive illuminations in respective order indicator 10, indicator 11, indicator 12, indicator 13, and indicator 14.

The arrangement of FIG. 2B is particularly valuable for naps and shorter sleep sessions. For short durations, such as only a few minutes to a few hours, there is a significant likelihood that a child waking early will fail to sleep for a larger percentage of the total duration than with a longer sleep period, and therefore the timing of such large-fraction intervals allow for observing the delayed value of full completion of a period of sleep. The child will get the benefit of observing that partial completion is only partially valuable to accumulating energy, and that there is a meaningful value to attempting to sleep for more intervals of time.

A child failing to get very much sleep during a brief period is thereby presented with a display of how healthy sleep requires getting the majority of the total period, and then the shorter duration for the last intervals emphasize that completion is only a little bit more time, but is disproportionately valuable to ensuring that sleep is practiced well. These relatively large fractional Intervals are particularly likely to promote a perception of progressive value with additional time intervals actually spent sleeping.

Referring now to FIGS. 2B and 2C, a first interval duration of zero time duration is used. This means that first indicator 10 is illuminated from the very beginning of a period of sleep. While the invention is contemplated in embodiments that use a nonzero time for the first interval, it is valuable to illuminate at least one indicator before the child falls asleep, because it provides the base reference point for understanding the energy value that has been gained, when waking up during later intervals. It also subtly serves as an encouragement to begin sleep on time, appreciating that the child is doing the first step of sleep just by going to bed.

Referring now to FIG. 2C, what is shown is a diagram of an alternative exemplary embodiment of setting the timing of the activation of the indicators 10-14, in a pattern of specified values for several of the interval durations. The values specified in this depicted embodiment are selected in order to achieve each of several goals achieved by remaining in bed until completion of the entire duration for the period of sleep.

This embodiment comprises an interval specified with a duration for a desired specified minimum healthy amount of sleep (“healthy sleep 25”), an interval with a duration for a desired amount of time for a child to stay in bed, in order to practice full compliance (“compliance 29”), and an interval specified with a duration for a desired amount of time for a child to stay in bed, in order to avoid interrupting the routine or sleep of a parent (“precompliance 27”).

The healthy sleep 25 interval is measured from the time of going to bed, and has an interval duration selected to be a low estimate of a reasonable amount of time to expect a child to need to sleep, in order to actually practice sleep that is healthy for the child.

For example, a child between the ages of 5 and 8 years old might reasonably be expected to need a minimum of 8.5 hours of sleep. Using 10 hours for duration “d,” the healthy sleep 25 interval duration could be set to 8 hours. This means that a child that is currently waking very early gets the benefit of seeing that no progress has been made (relative to merely beginning sleep at bedtime), and immediately knows that they must go back to sleep to achieve even one additional stage. However, as the child improves, they get to see the value of completing at least a second interval when they are close to a healthy amount of sleep.

A child that is waking early, but still getting at least a minimum amount of sleep, will reliably gets to see that they are still doing something meaningful for their body. Denying the second indicator 11 to be lit until truly reaching a typical minimum value of healthy sleep 25 would risk denying a child whose sleep is still nearly achieving this first goal is not being given an indicator that they have improved. It is essentially front-loading the incentive to use the device 3 as a routine, where falling short of healthy sleep becomes much closer to healthy sleep, even if the specified healthy sleep duration is not a uniformly agreed larger duration by any particular research or consensus of health measures or recommendations.

The point is to reward the child in improving with respect to at least one goal, beyond merely having gone to bed 8.5 hours earlier, and maximizing the opportunity that they get to regularly observe when it goes on, for a child that has been sleeping much less than an optimal healthy duration. Note that it is contemplated that any particular input value can be used for such an interval duration, the one used in FIG. 2C is merely one selected in order to facilitate description of an exemplary mode of an embodiment of the invention.

Precompliance 27 is shown as an interval measuring from the end time of the overall duration of the period of sleep that has an interval duration specified to increase the likelihood that a child perceives a need to stay in bed, in the event of a child waking up at a time that is likely to disturb the parent's sleep in a way that is likely to frustrate the coming day.

For example, a child that typically wakes up an hour early may result in a parent being deprived of a significant amount of uninterrupted sleep, but that time is close enough to the scheduled wake time that the parent may not be able to settle the child back to bed rapidly enough to re-claim a significant amount of the lost sleep. It is valuable for the indicator representing the beginning of this period (indicator 12) to be not-illuminated until the beginning of the precompliance period 27, so that a child that is otherwise getting a healthy amount of sleep is not persistently frustrating the ability of the parent to acquire their own necessary amount of energy.

The interval duration for precompliance 27 is selected, here to reflect a low estimate of the maximum amount of time that a parent believes that they could rise before the desired wake time and have only a small detriment to having the day be manageable, despite less-than-optimal amount-of-sleep. An exemplary estimate of what a parent would select for this interval duration is approximately 1 hour to 35 minutes.

Setting precompliance to a lower value increases the likelihood that delaying indicator 12 has the effect of actually promoting a child to remain in bed until after the time at which a parent would actually feel a frustration from a significant amount of sleep deprivation. Setting precompliance to a longer estimate means that indicator 12 would illuminate earlier, increasing the risk of inadvertently suggesting successful completion of the fourth interval at a time that is outside of the amount of time that a parent actually needs, in order to achieve the goal of having a precompliance 27 interval, avoiding the sleep-deprivation detriment. Here, precompliance 27 is set as a specified input of 45 minutes.

Compliance 29 is an interval having a duration specified to encourage a child that has managed to stay in bed long enough to not regularly cause their parent to experience sleep deprivation, to stay in bed just a little bit more, and make full completion of the sleep interval a desirable goal. The point is to attempt to curb a child that is merely being disobedient in waiting until reaching the time that the parent specifically has designated for sleep to be attempted. This interval is desirable to specify to so that a child gets to see the difference between depriving the parent of sleep (by staying in bed beyond the activation of indicator 12, marking the start of precompliance 27) and staying bed long enough that the child is close to completing sleep.

Here, compliance 29 is set as a specified input of 15 minutes. This way, a child staying in bed until 20 minutes before the desired wake time gets to see that they still have only 3 indicators illuminated (indicators 10, 11, 12), and gets to see the benefit of staying in bed just a little bit longer. Such a child gets the reward of indicator 13 only 5 minutes later. At that point, all that is left seems very small.

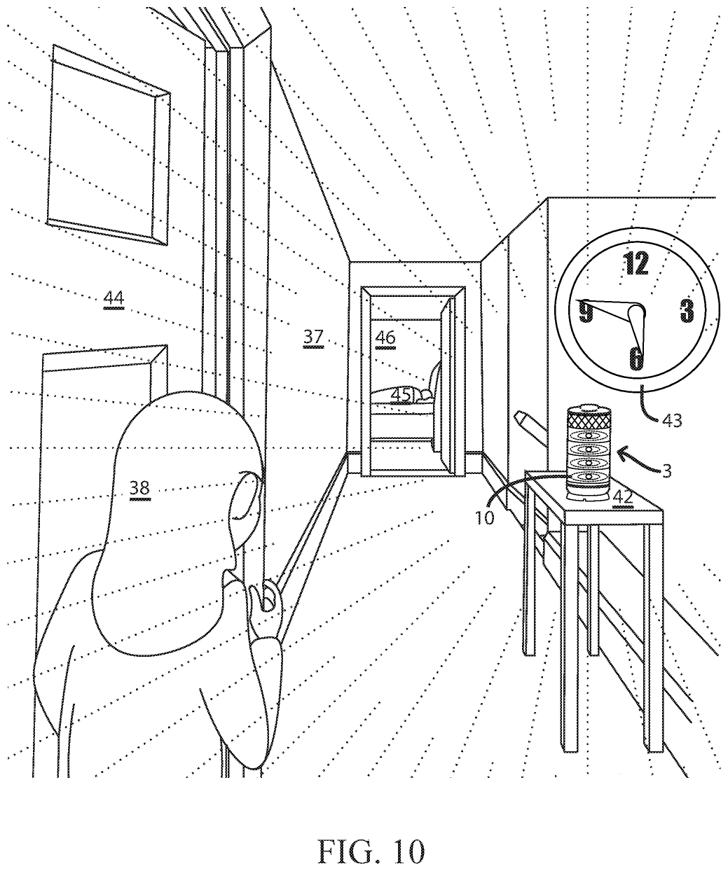

The remaining 15 minutes is longer than the 5 minutes that it took to acquire the illumination of the fourth indicator 13. Seeing a longer time pass to reach the fifth indicator promotes the understanding that the child completed something at least as long, and solidifying that the illumination of the fourth indicator 13 meant that the child nearly managed to sleep in an amount that is apparently ⅘ths of the way to a perfect amount of sleep. See FIG. 10.

Conversely, a longer precompliance 27 duration also ensures that a child waking only shortly after the beginning of precompliance 27 will not be rewarded with seeing 4 indicators illuminated for a significant period of time.

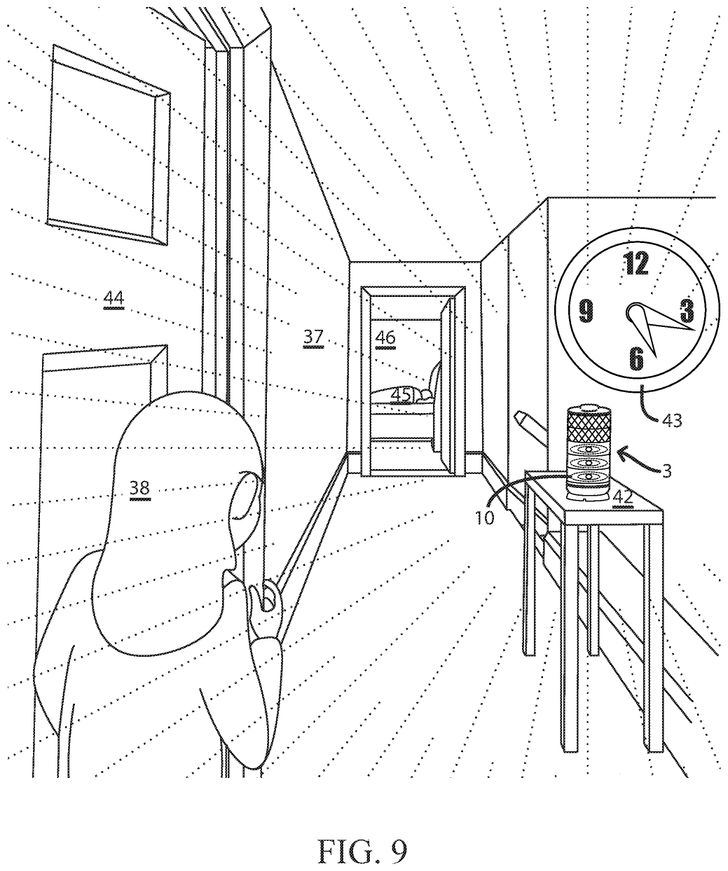

For example, with a 45-minute precompliance interval and a 15 minute compliance interval, waking at 44 minutes before the desired wake time will deprive the child of indicator 13 for another 29 minutes, nearly double the amount of time that it will take to illuminate indicator 14. See FIG. 9. The benefit in such case is that seeing the longer duration increases the likelihood that the child adopts a habit of seeing three lights as meaning there is still a significant amount of sleep left, and they really should try to go back to sleep. Such a child stands a larger chance of actually getting back to sleep, and doing so may bring them very close to waking at the desired time.

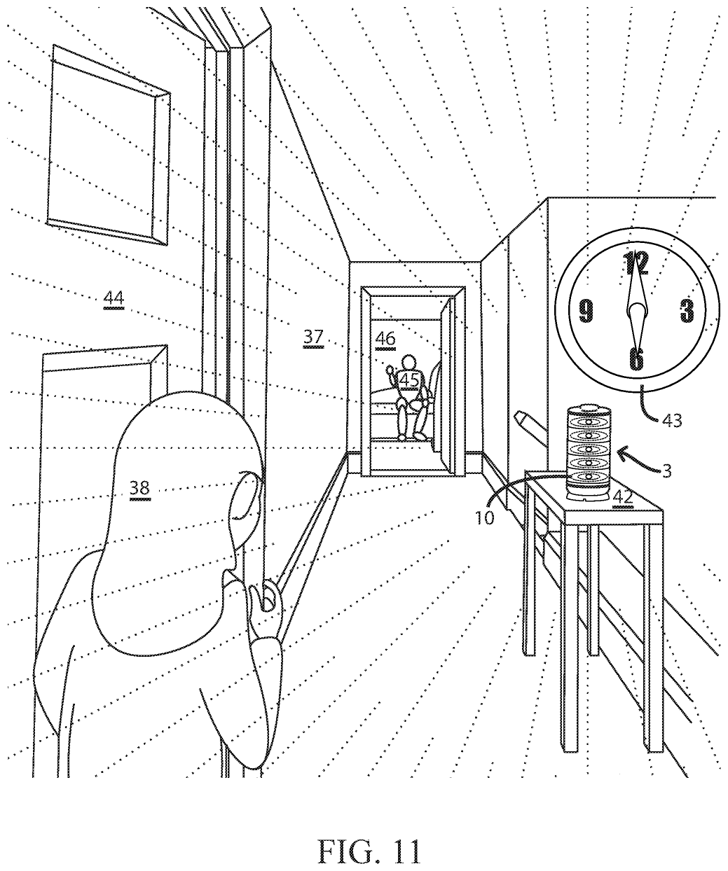

Finally, completion of the precompliance 27 and compliance 29 intervals are achieved at the time of illuminating the fifth indicator 14. A child waking and seeing all 5 indicators 10-14 is thereby accurately presented with a sign that they managed a full night of sleep. See FIG. 11.

It is important in all contemplated embodiments that the child gets the benefit of seeing that a sleep routine is a task, and that completion means an entire responsibility is fulfilled. In the case of a child regularly achieving a full night's sleep, they get a sense of having carried out all of a set of partial achievements, and therefore waking up no-earlier-than-expected is likely to foster a perception of doing well and being successful in what is being asked of them.

In all of FIGS. 2A-C, there are five indicators (10-14), but the invention is not limited to embodiments with specifically 5 indicators. Other contemplated embodiments do not necessarily specify a time for all of healthy sleep 25, precompliance 27 and compliance 29. In other contemplated embodiments, specification of an interval duration value may be omitted for any one of the intervals. In such case, the particular interval would have an interval duration provided by an algorithm which takes into account any interval duration is specified. See FIGS. 6A-D for an exemplary embodiment of how the remote controller 5 makes this possible.

Referring now to FIG. 3, what is shown are several people in a typical shared space, and shows several indicator device 3 locations in the shared space. Note that while the system (1, FIG. 1) is operable with at least one indicator device 3 (FIG. 1), there is no limitation on the system 1 to only comprise one indicator device, nor is there any limitation that multiple instances of the system 1 or multiple systems to not be co-functional in a shared space. This figure is provided to show the depicted exemplary embodiments' novel aspects that allow it to function with great mobility and ability to indicate energy and the approach of bedtime at a glance, from a variety of positions, to promote the realization that bedtime is approaching, and how these elements increase likelihood of practicing healthy sleep.

Here, the shared space shown is a multiple room setting of an open-floorplan-type home, including a foyer 31, a kitchen 33, a living room 35 with a high ceiling, and a balcony-type upstairs hallway 37. The people shown include three viewers 32, 34, 36, and a child 38. Indicator devices 3 are shown in several potential indicator locations: shelf 39, child's play table 40, counter 41, and balcony table 42. The device's (3) shape and arrangement of indicators allows anyone (including the child 38) to locate and relocate the device (3) to make it visible by multiple people in any of these locations (33, 35, 37). Therefore, the arrangement of the device 3, when located at any-of (or each-of) the several locations (33, 35, 37), creates an enhanced likelihood of the device being seen, and thereby makes it more likely that the child 38 would be timely alerted that bedtime is approaching.

In each location, the device 3 is illuminated with only the first indicator 10 illuminated. The device 3 is operating in a mode in which it is progressively de-luminating a plurality of peripherally viewable indicators (9, see FIGS. 1, 2A-C) over the course of hours leading-up-to a scheduled bedtime. In the embodiment shown, the device 3 has been de-luminating its indicators 9 over the course of an entire day, since the end of a period of sleep. Such an embodiment is adapted to be controlled with the controller 5 in order to provide such a scheduled time, and select a pattern or algorithm to provide interval durations with which to time the de-lumination of a set of indicators 9.

Unlike in sleep, where understanding of the progressively greater value of each indicator is able to foster understanding energy-accumulation value, despite non-linear intervals, a child 38 is able to view the de-lumination pattern of the indicators 9 during all of their conscious daytime hours. Therefore, appreciation of the device 3, to represent discharging the “energy” acquired during the preceding period of sleep, is fostered by the device 3 illuminating its indicators (9, FIG. 1) in a way that reflects intervals passing more regularly during the conscious daytime.

The device 3 shown in FIG. 3 is adapted to variably colorize or dim the indicators with the progression of time, so that the partial consumption of such “energy” attributed to the intervals can be perceived with the same number of indicators. For example, at the end of the preceding sleep period, all of the indicators 9 may be lit in bright green. Over the course of a first interval, the fifth indicator 14 can fade, before completely deluminating. Then, the fourth indicator 13 can repeat the pattern of indicator 14 as it deluminates, and then in similar pattern for each of indicators 12, 11, and 10, respectively.

Alternately, for any of the indicators, the passage of each interval may be distinctly represented with an alternately desirable pattern for its respective indicator. For example, with the delumination of the first indicator 10 (last to deluminate), it may turn red or flash, to provide a distinctly noticeable value to its expiration, compared to the preceding indicators' delumination.

At the moment depicted in FIG. 3, indicator 10 is the only indicator illuminated, and is in a state of illumination reflecting that it is nearly the time of the scheduled bedtime for the coming period of sleep. It is at this moment that the device 3 has particular advantage in prompting the child 38 to notice that it is time to go to bed, especially by comparison to a typical clock.

High on the wall in the living room 35 is a large clock 43. The clock 43 is located so that it can be seen from both the living room 35 and the hallway 37. The parents thought that location might be a good way to inform the child 38, when exiting her bedroom (on the hall 37) that she should still be in bed, especially if the child were to enter the hall 37 at a time when a parent was also be in the living room 35.

Attempting to teach the child 38 to use the clock 43 may have failed, though, because using a clock to determine whether it is time to wake requires the ability to tell time and the conscientiousness to look to the clock 43. The clock 43 may also be difficult to read in the dark, during times of expected sleep. Even though the clock 43 is large and located for view from both the living room 35 and the hallway 37, it still requires viewing from an angle that provides a clear view of the face of the clock. Here, out of viewer 32 in the foyer 31, viewer 34 in the kitchen 33, viewer 36 and child 38 in the living room 35, and no one in the hallway 37, only viewer 36 is in a position to read the clock 43. Viewers 32 and 34 cannot see the clock because the ceilings in the foyer 31 and the kitchen 33, and are not in the field of view of the face of the clock 43. The child 38 cannot read the clock 43, because she is at such a low angle that her view of the clock is obstructed by its bezel and is far enough away from a frontal view of the clock 43 that the needles' offset from the face of the clock 43 does not allow the clock to be read accurately. In fact, there is no location in any part of the shared space that can allow for every viewer (32, 34, 36, and child 38) to see the clock 43.

Unlike the clock 43, the device 3 shows light and color peripherally, illuminating an area of any elevation view of the device, in relative spatial proportion to the amount of its frontal area, that it can be deciphered passively, without any intent to seek out a time value, from any peripheral position. Therefore, with device 3, only relative orientation provides any obstruction to each noticing that a scheduled bedtime is approaching. For example:

Viewer 32 can see the device 3 on the shelf 39, counter 41, and balcony table 42. Viewer 32 would easily be able to see the device 3 on the play table 40, but the child 38 is in the way.

Viewer 34 is facing the counter 41, as one frequently stands when doing tasks in a kitchen 33, and can only see the device 3 on the counter 41. But—for this deflected angle of view, though, Viewer 34 is at a position which has an unobstructed view of the device 3 at both table 40 and shelf 39.

Viewer 36 has a clear view of the play table 40, the shelf 39, and the balcony table 42, and only has an obstructed view of the device 3 on the counter 41 because of the angle of Viewer 34 in the kitchen.

The child 38 is shown noticing the device 3 on the balcony table 42, and can easily see the device 3 on the table 40, the shelf 39, and the counter 41.

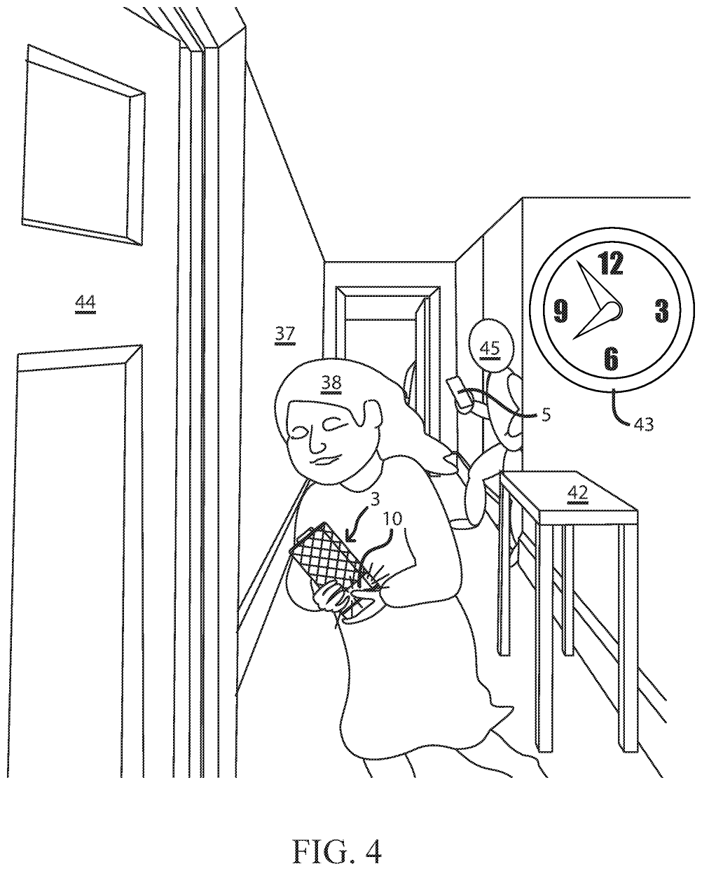

Referring now to FIG. 4, what is shown is a child 38 hurrying down the hallway 37 (see FIG. 3), carrying the indicator device 3. She noticed only a few moments earlier that device 3 was showing only a first indicator 10 illuminated (See FIG. 3), representing that a scheduled bedtime is impending, and retrieved it from the balcony table 42, to enter her bedroom door 44, and go to a place of sleep, her bed. It is light enough that she retrieved it as though it was any other child's toy, and is sized so that she can easily hold it without dropping it, even though it was big enough to see from a downstairs room. Because of the peripherally-emitted light, indicator 10 is visible even when both hands hold the device.

Parent 45 saw the child rush up to the hallway 37 and followed, carrying the controller 5, in anticipation of controlling the device 3, to check the state and specific inputs that the controller 5 has provided to the device 3. If necessary, the parent 45 can use wireless communications (15, FIG. 1) available to the controller 5 to edit the inputs provided to the device 3 via the wireless communications (17, FIG. 1) available to the device 3.

Referring now to FIG. 5, what is shown are exemplary embodiments of a device 3 in locations at a place of sleep, a child's bedroom. A child 38 is in her bed 47, and is accompanied with a device 3 laying on its side, in close proximity to her body and face.

The device 3 on the dresser 49 is standing upright, being charged on its charging dock 7, and has a plurality of indicators 9 arranged along its length, but only one indicator is illuminated, representing that the child has not completed a second interval of sleep, and has only been asleep for a few minutes. The device 3 is operating in a night-light mode, and emits a level of illumination selected to minimize the chance that light from the indicator 10 might wake the child 38.

The device 3 in the bed 47 comprises soft touch materials, and the cylindrical shape and materials of the device make it easy to hold and comfortable next to the child 38. None of the indicators of the device 3 in the bed 47 are illuminated, even though the device 3 is operating to monitor the passing of a second interval of sleep. This device 3 comprises an auto-off function that deluminates the indicators as desirable, using any of: a switch (23, FIG. 1) on the device, settings input to the device 3 by a remote controller (5, FIGS. 1, 4, 6A-D) of the system (1, FIG. 1), or input to the device from a schedule of saved input and settings. The schedule received the settings at an earlier time, by input from the remote controller, and being able to receive input and edits to input from the controller.

The device 3 in the bed 47 is adapted to illuminate a secondary set of indicators (21, FIG. 1) with the switch (23, FIG. 1). It is also adapted to be toggled with the switch (23, FIG. 1) into a mode of operation in which a primary set (plurality of indicators 9, FIG. 1) of indicators (indicators 10-14, FIG. 1, FIGS. 2A-C) are activated to illuminate with completion of successive intervals of time during the period of sleep (See FIGS. 2A-C).

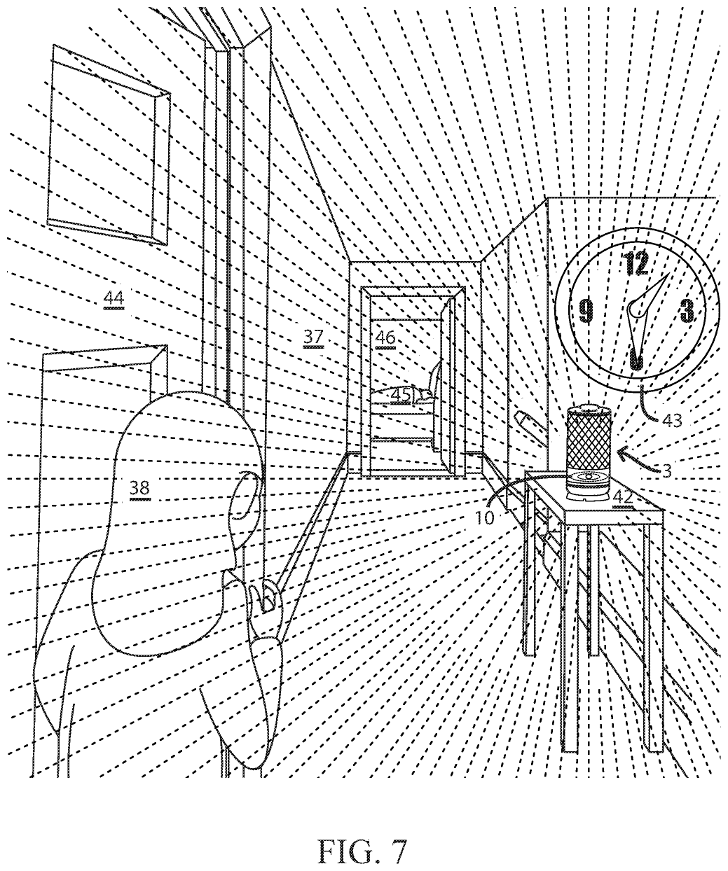

FIGS. 6A-D show exemplary graphical representations for an embodiment of a controller 15, with which a parent may provide inputs as settings, and save and edit and schedule periods of sleep, to be represented on an indicator device in proximity to a child (3, 38, FIG. 3) or to a place a child is likely to encounter, if they should leave their place of sleep (Such as device 3 on hallway table 42, FIGS. 7-11), as well as monitor an indicator device (3, FIGS. 1-5, 7-11), with respect to a period of sleep.

FIG. 6A shows a graphical representation of a set up controller screen. This represents the view that a controller 15 can present to a parent, to set up a period of sleep. There is a setup NAP/NIGHT mode selector 61, a duration selector 62, a pattern selector 63, and a start button 64. The mode selector 61 is in a position specifying NAP mode. Entering this mode effected preselecting the duration selector 62 to a 1 hour duration and the pattern selector 63 to a fractions-based option pattern. Both the duration selector 62 and pattern selector 63 are adapted to be controlled by a parent to respectively select from among alternative settings. Some exemplary alternative durations of time include 10 minutes, 20 minutes, 45 minutes, 1 hour 30 minutes, 2 hours. The pattern selector 63 is adapted to operate as a dropdown option selector or as an entry box. The present time is shown at the top of the controller screen, as 3:00 PM. The Start button displays “03:00:00 PM,” the time that will be used as the beginning of the sleep period, if the parent were to begin the period of sleep at this moment.

It is contemplated that the start button comprise other entry features in alternative controller screen embodiments, such as a dropdown box that gives options for when the period of sleep should occur, such as other specific times (03:01:00, . . . 04:15:00, . . . etc.) in the future or alternative durations of time delay (start in 5 minutes, 10 minutes, 1 hour, etc.), following the moment at which the parent presses start.

FIG. 6B shows a graphical representation of a monitoring controller screen. This represents the view that a controller 15 can present to a parent, during the course of a running period of sleep. The embodiment shown is monitoring the course of the nap which was set up in FIG. 6A. There is a time remaining display 65, an indicator illumination diagram 66, a edit button 67 and an end button 68.

The time remaining display 65 is showing in bold text the time remaining out of the total duration set up for the entire period of sleep, followed by a slash and the duration of the entire period of sleep. Here, the nap began at 3:00 PM, and it is presently 3:32 PM, and thereby the time remaining display accurately reflects that there is 00:28:00 (0 hours, 28 minutes, 0 seconds) remaining in the nap.

The indicator illumination diagram 66 resembles an elevation view of an indicator device 3 similar to those shown in FIGS. 1-5 and 7-11. It comprises 5 boxes (70, 71, 72, 73, 74), representing the status of each of 5 indicators (10-14, FIGS. 1-5, 7-11) of such devices in those other figures.

Each of the boxes has three indication-state appearance types. For intervals which are not presently running, the boxes representing the indicators to be lit for each such interval (See boxes 73 and 74) contain the interval duration for the particular interval, whether calculated or otherwise specified. For intervals that have been completed, the respective boxes (See boxes 71 and 72) comprise a graphic or other appearance that resembles an illuminated indicator. For intervals which are presently running, the respective boxes (See box 73) comprise an interval time remaining display 69. The interval time remaining display 69 displays in bold text the time remaining out of the interval duration for the particular interval, followed by a slash and the overall interval duration time for the particular interval.

To the right of the boxes is an interval completion time list, reflecting when each interval should end, based on the present input settings of the running nap. The interval completion times for intervals which have been completed appear in italicized text that is smaller than the size of the regular font times corresponding to boxes representing running intervals and ones which have not yet run.

Here, in this particular instance, the durations have been set according to the “0,d/3,d/3,d/5, remainder” fraction pattern (63, FIG. 6A; FIG. 2B) option. For the 1 hour nap, this means that the completion time of the final interval is 4:00 PM, and 4:00 PM appears in the interval completion time list next to the fifth box 74). The first interval is completed 0 time later (3:00 PM in the completion time list), The second and third intervals are both completed 20 minutes later, successively (3:20 and 3:40), the fourth interval is completed 12 minutes later (3:52). The remainder time for the fifth box 74 is calculated as the difference between the end of the fourth interval (3:52) and the end of the duration of the period (4:00 PM), equaling 8 minutes.

The present time is 3:32 PM, after the 3:00 and 3:20 completion times of the first and second intervals, respectively. Therefore, boxes 70 and 71 appear with the graphic resembling an illuminated indicator, and 3:00 and 3:20 appear in smaller italicized text. The fourth interval begins at the completion time of the third interval, 3:40 PM, which is in the future, so boxes 73 and 74 contain their 12 and 8 minute durations, respectively, and their corresponding completion times appear in regular text. 3:32 is between 3:20 and 3:40, so the third box 72 contains the remaining time until completion of the third interval (8 minutes remaining until 3:40 PM), and is followed by the 20 minute interval duration of the third interval.

Referring now to FIG. 6C, what is shown is a graphical representation of an editing controller screen. A parent viewing this controller screen arrived at this screen by tapping the edit button (67, FIG. 6B) during the present running nap. There is an additional time selector 75, a distribute option selector 76, two incomplete interval distribution selectors (77 and 78), and a new remaining-time display 79. There is also an indicator illumination diagram 66, boxes 70-74, with interval completion times listed next to each of the boxes 70-74.

Here, the parent has selected to add 00:20:00 (0 hours, 20 minutes, 0 seconds) to the nap. This means that the end of the period is extended to 4:20 PM, and is shown as an updated completion time to the right of the fifth box 74. The distribute option selector 76 is set to “EVENLY”, meaning that the time added will be distributed in equal amounts across the remaining intervals, which includes running and future intervals, but not completed intervals.

The present time is 3:41 PM. This is after the completion time of the third interval, 3:40 PM, and it is too late to extend the interval duration for the third interval. Boxes 70 71 and 72 are all showing the appearance of an illuminated indicator. The fourth interval is presently running, having started one minute earlier, and the fifth interval has not started. This means that the 20 minutes can be distributed across only the two incomplete intervals, the fourth and fifth. This is why there are only two incomplete interval distribution selectors (77 and 78), and why they appear next to boxes 73 and 74.

The incomplete interval distribution selectors 77 and 78 have been pre-selected to “+00:10:00” because the distribute option selector being selected to “EVENLY” effected the controller to divide the overall 20 minute additional time across the two remaining intervals. The individual interval distribution selectors 77 and 78 allow the parent to customize as desired how much of the additional time is attributed to each interval, and override the preselected inputs originally dictated by the distribute option selector 76.

The additional 10 minutes attributed to the fifth interval increases its interval duration from 8 minutes (see FIG. 6B) to 18 minutes (displayed on the box 74). Because the fifth interval is set to end at 4:20 PM, the completion time of the fourth interval is adjusted to 4:02 PM. Because the fourth interval is the presently running interval, the ten minutes added to the fourth interval increases the time remaining to 21 minutes (3:41 is 11 minutes before the original end time of the third interval, 3:52, see FIG. 6B), and the overall interval time for the fourth interval is increased to 22 minutes).

The new remaining-time display 79 now accounts for the overall nap duration being increased by 20 minutes to 01:20:00, and that the time remaining is also 20 minutes longer, at 39 minutes.

FIG. 6D shows a graphical representation of an alternative set up controller screen. There is a setup NAP/NIGHT mode selector 61, that is similar to the mode selector 61 of FIG. 6A. Here, though, the mode selector is in a position specifying NIGHT mode.

There is a DURATION/END period selector 87, which is in a position specifying END.

There is a start time selector 80, which is set to 8 PM. Because the period selector 87 is selecting END, there is an end selector 81. The end selector is set to 6 AM. There is an INTERVALS/ALGORITHM selector 88 that is positioned such that INTERVALS is selected. There are also: a 1st interval selector 82, a 2nd interval selector 83, a 3rd interval selector 84, a 4th interval selector 85, and a fifth interval selector, 86. Each of these selectors are set in a similar manner to the exemplary specified inputs of FIG. 2C:

1st is set to 0, 2nd is set to 8 hours (beginning), 5th is set to 15 minutes (end), 4th is set to 45 minutes (end), and 3rd is set to “calculated.” The present time is 7:45. There is a start button 64, like FIG. 6A, but it instead displays “Starts in 00:15:00.”, which is the amount of time remaining between the present time and the scheduled start time selected in the start time selector (80), 8:00 PM.

Note the discrepancy between 7:45 PM and 8:00 PM. The settings that are inputs made before the beginning of the period are stored for the future period that has yet to run. The applicant contemplates embodiments that store such inputs provided before future periods in a schedule of inputs. Then, at the time of a period, the control 5 can send the predetermined inputs stored in the input schedule to the device 3, to control the behavior of the device 3 during the period.

FIGS. 7-11 show a child 38 viewing an indicator device 3 in a hallway 37, on a hallway table 42, after waking from sleep at various times with respect to a period of sleep. In all of the figures, the child is standing in front of her bedroom door 44, looking down the hallway 37, at a parent's bedroom 46. A clock 43 appears on the wall, beyond a little hallway balcony wall. See FIG. 3.

In all of FIGS. 7-11, the sleep period is similar in duration and interval timing and duration to the sleep period discussed in FIG. 2C.

The sleep period is a night mode, with an overall duration is set to 10 hours, beginning at 8 PM, and ending at 6 AM. The period comprises five intervals. The first interval is of zero time duration, beginning at 8 PM. The second interval is a healthy sleep interval with a specified eight hour interval duration, beginning at the end of the first interval, and therefore ending at 4 AM. The fourth interval is a pre-compliance interval equal to 45 minutes and ends at 6 AM. The fifth interval is a compliance interval equal to 15 minutes, and ends at 6 AM. The third interval is the calculated remainder of the time of the overall duration, ending at the completion of healthy sleep, at 4 AM, and ending at the beginning of the pre-compliance interval, at 5:15 AM, the calculated duration thereby being 1 hour and 15 minutes.

In these embodiments, the device 3 has been positioned in the hallway 37, on the balcony hallway table 42, so that the child 38 will know to go back to bed and not approach the parent's bedroom 46 until all five indicators are lit. In this position, the device 3 would be functional even without a night light or dimmed mode, and would be protected against waking the child in proximity to the lights, and therefore is an excellent way to use the device in order to take advantage of the device's passive visibility advantages over a clock. In time, this strategy may also be useful to acclimate a child to the relative value of a clock and desist developing an inner sense of the passage of time associated with particular times on o'clock, assisting learning the ability to tell time.

Referring now to FIG. 7, the child is awake at 1:30 AM. The hallway 37 is very dark. The child has been asleep since 8 PM, and therefore is awake five hours and 30 minutes into the overall period of sleep. Despite being more than halfway to the desired wake time, this remains within the second interval, and the child is only shown one indicator, the same one that was illuminated at the very beginning of bedtime.

The child 38 cannot see the clock 43, and is unlikely to be able to even see the end of the hallway 37, in order to decipher whether the parent 45 is awake. The little amount of light emitted from the indicator 10 is only enough to make it unequivocal that the child has not slept very long, and is barely enough to elevate the amount of light in the hallway 37.

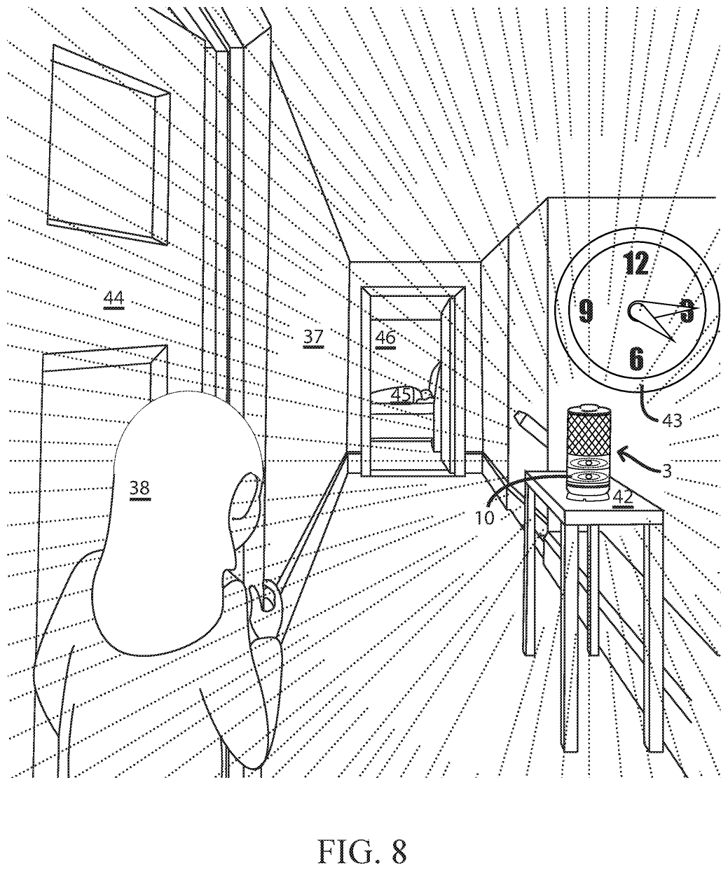

Referring now to FIG. 8, the child 38 is awake at 4:15 AM. The hallway 37 is still relatively dark, but the child has awoken 8 hours and 15 minutes following bedtime, longer than the healthy sleep interval, and is rewarded with two indicators being illuminated. The child 38 does not know how much time has passed, but does know that she cannot take this as a success, even if getting this much healthy sleep has made them feel ready for the day, because they know that many more lights need to be illuminated. Whether they feel refreshed at this point, they have clear feedback that they have made progress and can do even better.

Referring now to FIG. 9, the child 38 is awake at 5:20 AM. Sunrise is less than two hours away, and the hallway 37 is significantly brighter. Three indicators are illuminated. The child 38 does not know how much time has passed, nor that she only has another 40 minutes to go. She only knows that it is not time to wake up and she cannot take this as a complete success, because there are two other indicators that are not illuminated.

Referring now to FIG. 10, the child is awake at 5:47 AM. The fifth interval, compliance, began 2 minutes earlier, and four indicators are illuminated. At this point, the amount of light in the hallway 37 is likely to make the child 38 feel that it is time to start the day, but the child knows that she is supposed to go back to bed, if only because there is just one more indicator left to be illuminated.

Referring now to FIG. 11, the child is awake at 6 AM, right on time. All of the indicators are illuminated, and the child 38 knows that she has succeeded in completing all the intervals. The parent 45 is awake, and is waving to the child from the parent's bedroom 46, and now the child 38 knows that it is appropriate to start the day.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A system comprising a device that comprises a plurality of indicators,
the indicators comprising interval completion indicators,
an interval completion indicator being an indicator that is adapted to alternately activate to visually indicate completion of an interval of a period over which a task is performed,
a period being characterized by a period duration,
an interval being characterized by an interval duration,
such that the cumulation of the interval durations equals the period duration,
the system further being adapted to train a person to perceive progressive completion of a period by sequential activations of indicators according to a sequence of completion of said interval durations.

2. The system of claim 1, wherein the system is mobile by comprising wireless communications, the system further comprising a control, the control being adapted to monitor and provide input to said device with said wireless communications, before beginning a period and during any interval.

3. The system of claim 1, wherein the system is mobile by the device being adapted to continuous operation by being alternately powered by an internal battery and an external electrical energy source, and comprising a size and shape adapted to be grasped, held, and carried by a child.

4. The system of claim 1, wherein interval durations are calculated by inputs of at least two of a start time, an end time, a duration, and a desired non-linear interval duration algorithm, the algorithm being one selected from a list of non-linear patterns and functions, comprising: a set of desired fractional multipliers of a period, exponential decay, a bell curve, a step function, logarithmic progression, and a set of sequential non-linear intervals, sequential non-linear intervals meaning that the set of intervals comprises at least one interval that begins after an interval that has a different interval duration.

5. The system of claim 4, wherein input comprises predetermined input stored and accessed in an input schedule.

6. The system of claim 4, wherein the input further comprises a first desired compliance interval, a compliance interval being an interval of a desired interval duration and which reaches completion at the completion of the period duration.

7. The system of claim 6, wherein input further comprises a desired pre-compliance interval, the pre-compliance interval being a compliance interval having a desired interval duration that is greater than the interval duration of said first compliance interval.

8. The system of claim 4, at least one interval being a goal interval,
a goal interval being an interval having an interval duration pre-determined to achieve a goal of the period,
input further comprising at least one desired interval duration for the goal interval,
the interval duration of the goal interval being a duration selected to achieve the goal of being unconscious for a duration that is approximately as long as a healthy amount of sleep, one selected from: a typical duration for a person to sleep and a minimum healthy duration for a person to sleep, the duration being predetermined with respect to at least one of the age of a person to complete the period of sleep and the state of health of the person.

9. The system of claim 4, at least one interval being a goal interval,
goal interval being an interval having an interval duration pre-determined to achieve a goal of the period,
input further comprising at least one desired interval duration for the goal interval,
the interval duration of the goal interval being a duration to achieve the goal of preventing a child from rising from a period of sleep before a desired time to wake, the duration being selected to be shorter than the approximate amount of time that the child rises before the desired time to wake, such that the device comprises at least one indicator that is not activated at the time that the child wakes before the desired time to wake.

10. The system of claim 1, wherein the device is adapted to train a person to perceive progressive completion by comprising a shape of a storage device, such that sequential activation of indicators resembles stepwise filling of the storage device, the storage device having the shape of a common battery, one selected from a list comprising all of: common battery types, cylindrical batteries, and batteries having an elongate shape characterize with a predominant length, common battery types comprising at least one type selected from: C, AAA, AA, D, 9V, and 12V.

11. The system of claim 1, the system being further adapted to train a person to perceive progressive completion by activation of indicators being visible from many locations peripherally about the device, by indicators emitting light peripherally outward from the device.

12. The system of claim 1, the system being further adapted to train a person to perceive progressive completion by the device being adapted to be grasped,
by comprising at least one of soft materials, and
a size and shape that is adapted to be grasped or held by a person during a period of sleep, and
by being adapted to minimize the risk of illumination disturbing sleep,
by comprising at least one light coloration or illumination adjustment mode selected from a list comprising a night light mode that decreases overall brightness, automatic deactivation of indicators that emit light, and
wherein said indicators are alternately selectably illuminable and de-luminable with said switch, to alternately illuminate indicators which represent completed intervals.

13. The system of claim 12, wherein
the indicators are a primary set of indicators, and
the device further comprising a secondary set of indicators that do not emit light peripherally about the device,
wherein the device is further adapted to minimize the risk of illumination disturbing sleep by the device being adapted to alternately illuminate one selected from the primary set of indicators and secondary set of indicators.

14. The system of claim 1, wherein
the system is adapted to (promote the perception of a period of sleep as being a period of accumulation of energy by comprising at two sequential periods that each have a period duration, the first period being a period of sleep that comprises intervals having interval durations that are non-linear in interval duration for at least two successive intervals, and wherein said indicators sequentially activate with the completion of each successive interval

15. The system of claim 14, and further,
the second period being a period of consciousness, and wherein said indicators sequentially de-activate with the completion of each successive interval.

16. The system of claim 2, wherein said control comprises plural alternate setup modes, comprising at least a nap mode and a night mode, wherein said nap mode comprises input of a duration for the period of sleep and comprises input of a selection of an algorithm with which to calculate interval durations during the period of sleep, and wherein night mode comprises input of a selection of one of duration and end time and comprises input of a start time, and is adapted to receive input for desired interval durations.

17. The system of claim 2, wherein said control is adapted to monitor and control the device by being adapted to communicate with the device by comprising the use of a mobile communications device having a display screen and wireless communications, to view and edit the inputs and period duration and interval durations of the period, to control the behavior of the device, during the period.

18. The system of claim 2, wherein said control is adapted to monitor and control the device by being adapted to communicate with the device by comprising the use of a mobile communications device having a display screen and wireless communications, to view the interval progression and indicator status.
